(19) United States
(12) Patent Application Publication
(10) Pub. No.: US 2007/0222297 A1
(43) Pub. Date: Sep. 27, 2007

(54) Power Supply Device of an Electronic Device

(76) Inventor: Min-Hui Hung, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/420,769

(22) Filed: May 29, 2006

(30) Foreign Application Priority Data
Mar. 23, 2006 (TW) 095110124

(51) Int. Cl. H02J 9/00

(52) U.S. Cl. 307/66

(57) ABSTRACT

A power supply device includes a DC power output module for outputting a DC power source, a DC power transformation module coupled to the DC power output module for transforming a voltage level of the DC power source, a diode including an input end coupled to an output end of the DC power transformation module and an output end, and a charge storing module coupled to the output end of the diode for storing charges.

### BACKGROUND OF THE INVENTION

1. Field of the Invention

The present invention relates to a power supply device of an electronic device, and more particularly, to a power supply device for decreasing production costs and for enhancing an ability to prevent electrostatic discharge.

2. Description of the Prior Art

As technologies advance, there are more and more functions in electronic devices. In order to operate an electronic device normally, whether the electronic device is turned on or turned off, some elements of the electronic device have to work continuously. Therefore, there must be a power supply device in the electronic device for supplying power to the continuously working elements of said electronic device while said electronic device is turned off. For example, when an electronic product such as a computer system, a digital camera, or a television, is switched off, or is not electrically connected to an external power source, power is outputted from a battery to a time-counting device such as a real time clock generating device for maintaining data stored in a memory chip such as a BIOS. Although power consumed by a real time clock-generating device or by a memory chip is low, however, as time goes on, the battery may run out of electricity so that the stored data in the memory chip will loss, or the generated clock of the real time clock generator will miss. For overcoming the abovementioned problems, a power supply device in the prior art is provided. The power supply device of the prior art uses a rechargeable battery for supplying power to the continuously working elements.

Please refer to FIG. 1, which is a diagram of a power supply device 10 of an electronic device of the prior art. The power supply device 10 is for providing power to a chip 118 and a time-counting and memory unit 120 of the chip 118. The power supply device 10 comprises a DC power socket 100, a battery socket 102, a power switching circuit 104, a voltage-booster DC-to-DC voltage transformation circuit 106, a switch circuit 108, two diodes 110 and 112, a resistor 114, and a rechargeable battery 116. The DC power socket 100 is for plugging in an output terminal, which is not illustrated in FIG. 1, of an AC-to-DC converter. The battery socket 102 is for plugging in a battery. The power switching circuit 104 is for switching the power source provided by the DC power socket 100 or by the battery socket 102 to the voltage-booster DC-to-DC voltage transformation circuit 106 and to the diode 112. After a DC voltage level of DC power is increased by the voltage-booster DC-to-DC voltage transformation circuit 106, the DC power is transmitted to the switch circuit 108.

The switch circuit 108 is turned on when the corresponding electronic device is turned on, for supplying power outputted from the voltage-booster DC-to-DC voltage transformation circuit 106 to the chip 118 and to the diode 110 for operating related operations. The switch circuit 108 also provides a higher voltage level for increasing stored charges in the rechargeable battery 116 and for extending a working time of the time-counting and memory unit 120. The switch circuit 108 is turned off when the corresponding electronic device is turned off, to reduce power consumption. Both the diodes 110 and 112 are one-way switches. When the voltage levels of the input ends of the diodes 110 and 112 are respectively higher than the voltage levels of the output ends of the diodes 110 and 112, the diodes 110 and 112 are turned on accordingly for supplying power to the time-counting and memory unit 120, and for charging the rechargeable battery 116 through the resistor 114. Therefore, when the power supply device 10 is electrically connected to an external power source, i.e., when the DC power socket 100 is plugged an output terminal of an AC-to-DC converter in, or when a battery is plugged into the battery socket 102, the power switching circuit 104 supplies power to the time-counting and memory unit 120 through the diode 112 and charges the rechargeable battery 116.

On the contrary, when the power supply device 10 is not electrically connected to an external power source, the rechargeable battery 116 provides its stored power for the time-counting and memory unit 120 through the resistor 114 for maintaining a continuous working of the time-counting and memory unit 120. Since the diodes 110 and 112 are both one-way switches, the diodes 110 and 112 prevent power supplied by the rechargeable battery 116 from transmitting to the switch circuit 108 or to the power switching circuit 104. In other words, no matter whether the electronic device is turned on or turned off, the time-counting and memory unit 120 receives necessary operational power. Since the rechargeable battery 116 will be charged when the power supply device 10 is electrically connected to an external power source, the rechargeable battery 116 does not lack power resulting in lost stored data in the memory chip or missing the counted time in the time-counting device.

That is, through the power supply device 10, no matter if the electronic device is turned on or turned off, the time-counting and memory unit 120 works continuously. Moreover, as long as an external power is electrically connected to the power supply device 10 within a reasonable time, the rechargeable battery 116 would not be exhausted. However, as a path 122 shown in FIG. 1, when the power supply device 10 is electrically connected to an external power source, the power switching circuit 104 not only charges the rechargeable battery 116 through the diode 112, but also transmits power to the time-counting and memory unit 120 through the path 122.

Generally speaking, the time-counting functions of the time-counting and memory unit 120 are provided by oscillators, comparators, and counters. When the time-counting and memory unit 120 is more precise and more accurate, the circuitry of the time-counting and memory unit 120 is more complex, the number of elements in the time-counting and memory unit 120 is increased, and the time-counting and memory unit 120 is more easily affected by an electrostatic discharge (ESD) effect. In FIG. 1, when the power supply device is electrically connected to an external power source, the power switching circuit 104 transmits power directly to the time-counting and memory unit 120 through the path 122. In other words, there is a signal transmitting path or an electrostatic discharging path between the time-counting and memory unit 120 and the power switching circuit 104 so that the operations of the time-counting and memory unit 120 are affected by surrounding high frequency noises or static charges through the path 122, and the counted time of the time-counting and memory unit 120 may also be missed or be reset to zero. The electrostatic discharge effect is a primary factor of electrical overstress (EOS) damages on electronic elements or on electronic devices, and such damages permanently damage semiconductor elements and thus affect functions of integrated circuits. When electronic elements and electronic devices are manufactured, produced, fabricated, tested, deposited, and transported, electrostatic charges accumulate in human bodies, instruments, storage devices, or even the electronic elements. Then, when those objects contact each other, a discharging path is generated so that the electronic elements and the electronic devices are damaged, and the abovementioned phenomenon is what generates the electrical overstress damages.

In other words, the power supply device 10 of the prior art may be affected by electrostatic discharges so that the counted time is missed or is reset to zero, and the operations of the corresponding electronic device is thus affected.

### SUMMARY OF THE INVENTION

Therefore, the primary aim of the present invention is to provide a power supply device of an electronic device that has an enhanced ability to prevent electrostatic discharge.

The claimed invention provides a power supply device of an electronic device. The power supply device comprises a DC power output module for outputting a DC power source, a DC power transformation module having an input end coupled to the DC power output module for adjusting voltage of the DC power source, and an output end, a first diode having an input end coupled to the output end of the DC power transformation module, and an output end, a charge storing module coupled to the output end of the first diode for storing charges, and a first loading unit coupled to the charge storing module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a power supply device of an electronic device of the prior art.

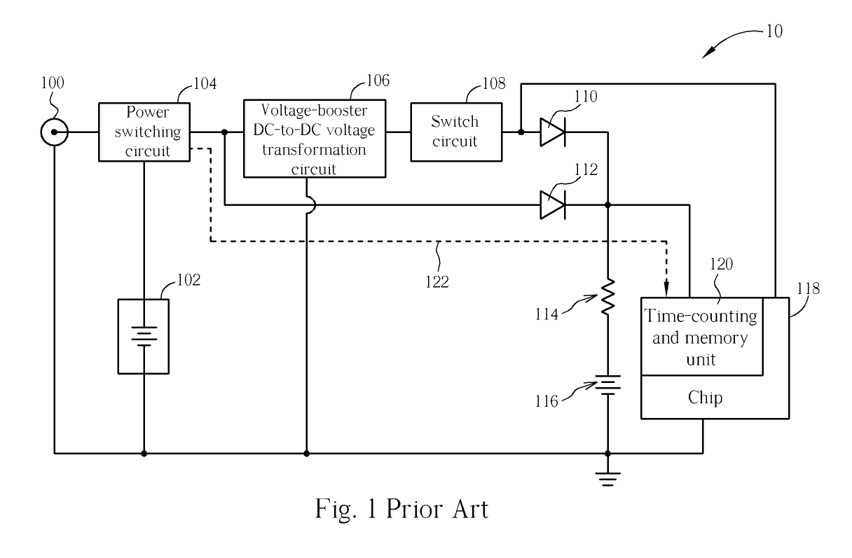

FIG. 2 is a diagram of a power supply device of an electronic device according to a preferred embodiment of the present invention.

FIG. 3 is a diagram of a voltage-booster DC-to-DC voltage transformer of the prior art.

FIG. 4 is a diagram of the control circuit of the voltage-booster DC-to-DC voltage transformer shown in FIG. 3.

FIG. 5 is a diagram of a voltage-reduction DC-to-DC voltage transformer of the prior art.

FIG. 6 is a diagram of a power supply device of an electronic device according to a preferred embodiment of the present invention.

### DETAILED DESCRIPTION

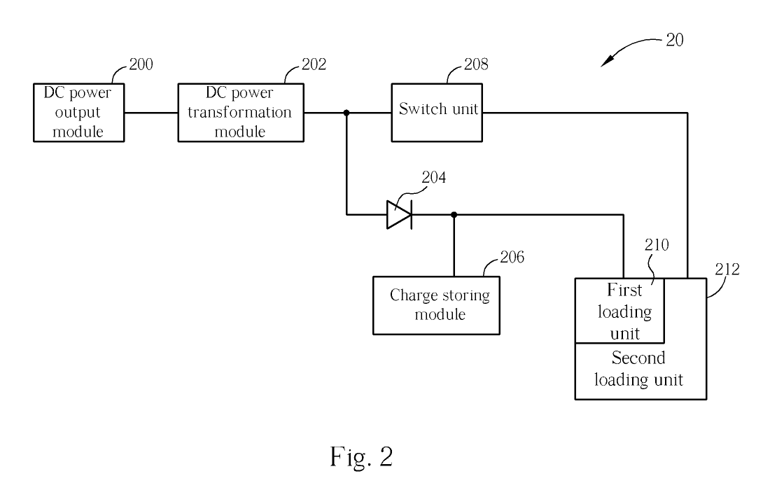

Please refer to FIG. 2, which is a diagram of a power supply device 20 of an electronic device according to a preferred embodiment of the present invention. The power supply device 20 is for enhancing an ability to prevent electrostatic discharges. The power supply device 20 comprises a DC power output module 200, a DC power transformation module 202, a diode 204, and a charge storing module 206. The DC power output module 200 outputs DC power to the DC power transformation module 202. The DC power transformation module 202 raises or reduces a voltage level of the received DC power to a predetermined value, then the raised or reduced DC power is outputted to the charge storing module 206 through the diode 204. The charge storing module 206 stores charges and outputs the stored charges to a first loading unit 210. The first loading unit 210 may be a continuously-working element such as a real time clock generating module or a storing module. Additionally, preferably, the DC power transformation module 202 outputs power to a second loading unit 212 through a switch unit 208. The second loading unit 212 may be an operational chip of an electronic device or a microprocessor. When the electronic device is turned on, the switch unit 208 generates a current path between the DC power transformation module 202 and the second loading unit 212 for activating the second loading unit 212. In other words, the first loading unit 210 is a continuously-working module of the electronic device whereas the second loading unit 212 is merely activated when the electronic device is turned on.

Through the power supply device 20 and when the DC power output module 200 outputs power, no matter whether the electronic device is turned on or turned off, the DC power transformation module 202 raises or reduces a voltage level of the DC voltage outputted by the DC power output module 200, then the DC power transformation module 202 transmits a corresponding current to the charge storing module 206 and to the first loading unit 210 through the diode 204. When the DC power output 200 ceases to work, a voltage level at the input end of the diode 204 would be lower than a voltage level at the output end of the diode 204 so that the diode 204 is switched off, thereby, the stored charges of the charge storing module 206 are transmitted to the first loading unit 210 for maintaining the operations of the first loading unit 210. In other words, when the DC power output module 200 outputs power, a current outputted by the DC power output module 200 flows to the first loading unit 210 through the DC power transformation module 202 and the diode 204. Since there are coupling elements such as capacitors and inductors in the DC power transformation module 202, said coupling elements would act as filters for absorbing or neutralizing current pulses generated from noises or electrostatic discharges. Therefore, by the protection provided by the DC power transformation module 202, the first loading unit 210 is not affected by electrostatic discharges for protecting the elements of the first loading unit 210.

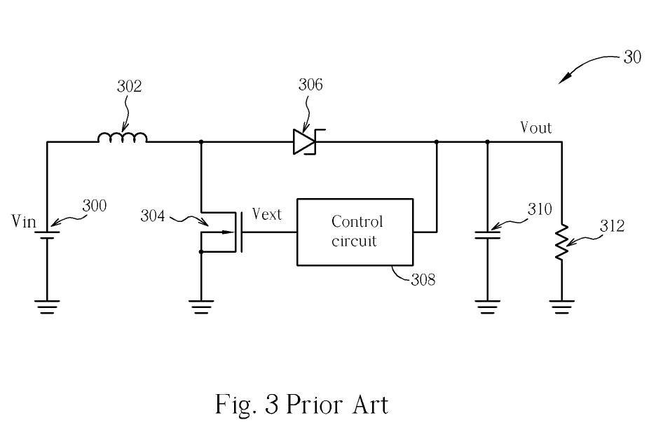

Note that as long as a replacement of the DC power transformation module 202 can transform DC voltages, the replacement of the DC power transformation module 202 is not restricted. For example, please refer to FIG. 3, which is a diagram of a voltage-booster DC-to-DC voltage transformer 30 of the prior art. The voltage-booster DC-to-DC voltage transformer 30 comprises a power source 300, an inductor 302, a switch transistor 304, a diode 306, a control circuit 308, a capacitor 310, and a loading resistor 312. The control circuit 308 controls whether switch transistor 304 is turned on or turned off according to an output voltage of the diode 306 for raising a voltage level of a voltage Vin of the power source 300 to an appropriate value and outputting the raised voltage as a voltage Vout shown in FIG. 3 by the diode 306. When the switch transistor 304 is switched on, the diode 306 is reversely biased and is not conductive so that the power source 300 charges the inductor 302, thereby, after the switch transistor 304 is switched off, the inductor 302 generates a reverse voltage accordingly. In other words, when the switch transistor 304 is switched on, the power source 300 charges the inductor 302, and after the switch transistor 304 is switched off, the energy stored in the inductor 302 is transmitted to the capacitor 310 and to the loading resistor 312 through the diode 306.

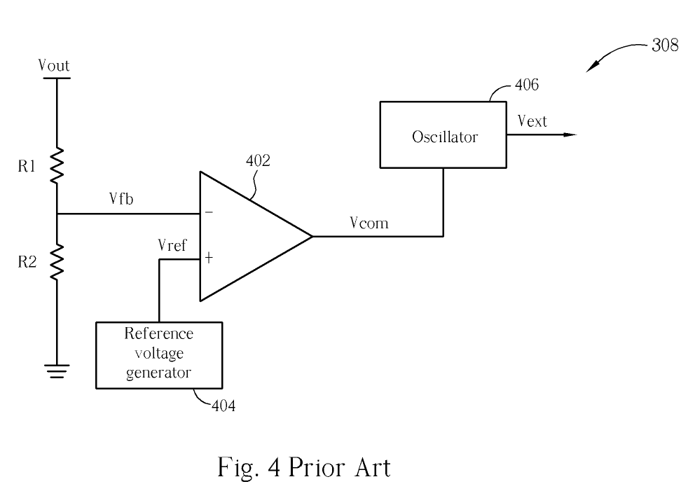

Please refer to FIG. 4, which is a diagram of the control circuit 308 of the voltage-booster DC-to-DC voltage transformer 30 shown in FIG. 3. The control circuit 308 comprises a comparison circuit 402, a reference voltage generator 404, an oscillator 406, and two resistors R1 and R2. The combination of the resistors R1 and R2 is a voltage-division circuit for transforming the output voltage Vout of the diode 306 into a voltage Vfb shown in FIG. 4, and the voltage Vfb is then transmitted to the comparison circuit 402. The comparison circuit 402 is for comparing the voltage Vfb with the reference voltage Vref outputted by the reference voltage generator 404. The oscillator 406 may be a pulse-width modulation oscillator, a pulse frequency modulation oscillator, or a ring oscillator, for outputting a control signal Vext for controlling the switch transistor 304 according to a comparison signal Vcom outputted by the comparison circuit 402.

When a voltage level of the output voltage Vout is lower than a target voltage level, a voltage level of the voltage Vfb is lower than a voltage level of the reference voltage Vref, then the comparison Vcom is at a high voltage level for enabling the oscillator 406 for switching on or switching off the switch transistor 304. On the other hand, when the voltage level of the output voltage Vout is higher than the target voltage level, the voltage level of the voltage Vfb is higher than the voltage level of the reference voltage Vref, then the comparison signal Vcom is at a low voltage level and disables the oscillator 406 for switching off the switch transistor 304.

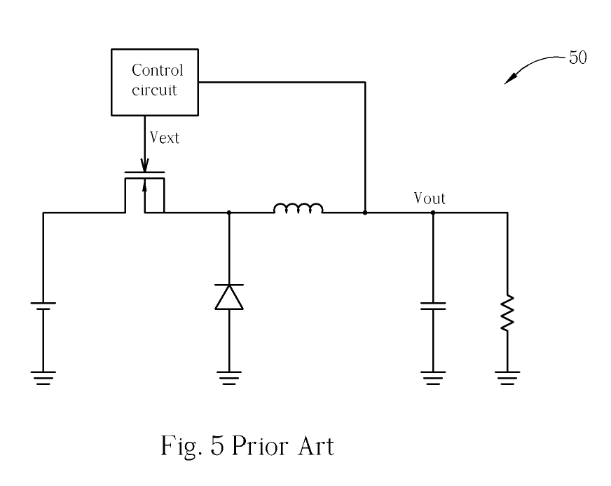

Moreover, please refer to FIG. 5, which is a diagram of a voltage-reduction DC-to-DC voltage transformer 50 of the prior art. The operations and the control circuits of the voltage-reduction DC-to-DC voltage transformer 50 are similar with the operations and the control circuits of the voltage-booster DC-to-DC voltage transformer 30, and are known by those skilled in the art so that the voltage-reduction DC-to-DC voltage transformer 50 will not be further described.

As shown in FIG. 3 and FIG. 5, there are coupling elements such as capacitors and inductors between the input end and the output end of the voltage-booster DC-to-DC voltage transformer 30 as well as the voltage-reduction DC-to-DC voltage transformer 50. The coupling elements are utilized for absorbing or neutralizing current pulses generated from noises or electrostatic discharges for preventing the first loading unit 120 from being damaged by the electrostatic discharges. Additionally, in FIG. 2, the DC power output module 200 is for providing DC power by plugging in an output terminal of an AC-to-DC converter to a DC power socket, or by plugging in a battery to a battery socket. In other aspects, the charge storing module 206 may be a rechargeable battery for storing charges and for outputting the stored charges to the first loading unit 120.

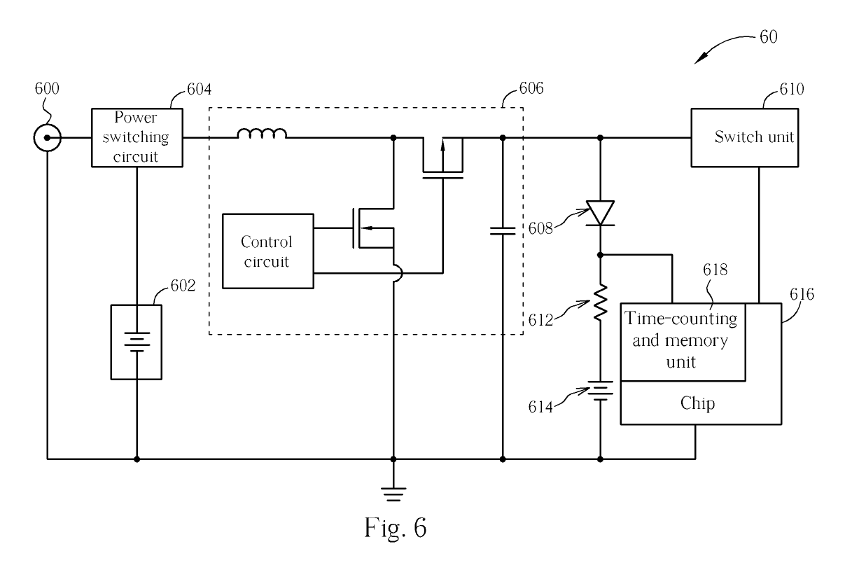

Please refer to FIG. 6, which is a diagram of a power supply device 60 of an electronic device according to a preferred embodiment of the present invention. The power supply device 60 is for providing power to a chip 616 and to a time-counting and memory unit 618 of the chip 616. The power supply device 60 comprises a DC power socket 600, a battery socket 602, a power switching circuit 604, a voltage-booster DC-to-DC voltage transformation circuit 606, a diode 608, a switch unit 610, a resistor 612, and a rechargeable battery 614. The DC power socket 600 is for plugging in an output terminal of an AC-to-DC converter, which is not shown in FIG. 6. The battery socket 602 is for plugging in a battery. The power switching circuit 604 is for selectively switching a coupling of the voltage-booster DC-to-DC voltage transformation circuit 606 between the DC power socket 600 and the battery socket 602, for raising a voltage level of a DC voltage and transmitting the raised DC voltage to the diode 608 and to the switch unit 610 through the voltage-booster DC-to-DC voltage transformation circuit 606.

In the preferred embodiment shown in FIG. 6, the operations of the voltage-booster DC-to-DC voltage transformation circuit 606 are similar with the operations of the voltage-booster DC-to-DC voltage transformer 30 shown in FIG. 3, however, a metal-oxide semiconductor transistor in the voltage-booster DC-to-DC voltage transformation circuit 606 replaces the diode 306. The switch unit 610 is switched on when the electronic device is turned on for transmitting power provided by the voltage-booster DC-to-DC voltage transformation circuit 606 to the chip 616 and for performing related operations. The switch unit 610 is switched off when the electronic device is turned off for saving power consumption, and generates a charging loop with a voltage-booster circuitry for charging the rechargeable battery 614 through the diode 608 and the resistor 612. The voltage-booster circuitry, which is the diode 306 shown in FIG. 3 or the voltage-booster DC-to-DC voltage transformation circuit 606 shown in FIG. 6, forms a body diode with a metal-oxide semiconductor transistor.

The diode 608 is a one-way switch. When a voltage level at the input end of the diode 608 is higher than a voltage level at the output end of the diode 608, the diode 608 is switched on for providing power to the time-counting and memory unit 618 and for charging the rechargeable battery 614 through the resistor 612. Therefore, when the power supply device 60 is electrically connected to an external power source, i.e., when the DC power socket 600 is plugged in with an output terminal of an AC-to-DC converter, or when the battery socket 602 is plugged in with a battery, the power switching circuit 604 supplies power to the time-counting and memory unit 618 through the voltage-booster DC-to-DC voltage transformation circuit 606 and charges the rechargeable battery 614. On the contrary, when the power supply device 60 is not electrically connected to an external power source, the diode 608 is switched off so that the stored charges of the rechargeable battery 614 are outputted to the time-counting and memory unit 618 through the resistor 612 for maintaining the continuous operations of the time-counting and memory unit 618. In other words, no matter whether the electronic device is turned on or turned off, the time-counting and memory unit 618 is supplied with necessary power for operations. Besides, since the rechargeable battery 614 may be charged when the power supply device 60 is electrically connected to an external power source, the stored data of a memory chip will not be lost, and the counted time of a time-counting device will not be missed either.

As shown in FIG. 6, when the power supply device 60 is electrically connected to an external power source, the power switching circuit 604 supplies power to the time-counting and memory unit 618 through the voltage-booster DC-to-DC voltage transformation circuit 606. Since the voltage-booster DC-to-DC transformation circuit 606 has coupling elements, which may be capacitors and inductors, and may act as filters, current pulses generated by noises or electrostatic discharges may be absorbed or neutralized for preventing the time-counting and memory unit 618 from being affected. Therefore, by the protection provided by the voltage-booster DC-to-DC voltage transformation circuit 606, the time-counting and memory unit 618 is not affected by electrostatic discharges. Moreover, compared with the prior art, fewer diodes are applied in the present invention for decreasing production cost.

In summary, the number of required diodes is decreased in the present invention. What is more important is, with the coupling elements of the DC power transformation module of the present invention, the time-counting and memory unit of the present invention is prevented from being affected by electrostatic discharges and high frequency noises. Therefore, the time-counting and memory unit of the present invention does not require electrostatic discharge preventing elements, for simplifying circuitry complexity, for decreasing production capital, and for improving the defects of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power supply device of an electronic device comprising:
a DC power output module for outputting a DC power source;
a DC power transformation module having an input end coupled to the DC power output module for adjusting voltage of the DC power source, and an output end;
a first diode having an input end coupled to the output end of the DC power transformation module, and an output end;
a charge storing module coupled to the output end of the first diode for storing charges; and
a first loading unit coupled to the charge storing module.

2. The power supply device of claim 1 wherein the DC power output module comprises:
a DC power socket for connecting to an output terminal of an AC-to-DC converter;
a battery socket for connecting to a battery; and
a power switching circuit coupled to the DC power socket, to the battery socket, and to the DC power transformation module, for selectively switching a coupling of the DC power transformation module between the DC power socket and the battery socket.

3. The power supply device of claim 1 wherein the DC power transformation module is a voltage-booster DC-to-DC voltage transformation circuit, the DC power transformation module comprising:
an inductor having a first terminal coupled to the DC power output module, and a second terminal;
a first switch element having a first terminal coupled to the second terminal of the inductor, a second terminal coupled to a system ground, and a third terminal, for transmitting a signal of the first terminal of the first switch element to the second terminal of the first switch element according to a signal received at the third terminal of the first switch element;
a second switch element having a first terminal coupled to the first switch element and the inductor, and a second terminal coupled to the input end of the first diode, for transmitting a signal of the first terminal of the second switch element to the second terminal of the second switch element when a voltage of a signal at the first terminal of the second switch element is higher than a first value; and
a control element coupled to the second terminal of the second switch element and to the third terminal of the first switch element, for controlling a duty cycle of the first switch element according to a power source outputted at the second terminal of the second switch element.

4. The power supply device of claim 3 wherein the first switch element is a metal-oxide semiconductor transistor, the first terminal of the first switch element is a drain, the second terminal of the first switch element is a source, and the third terminal of the first switch element is a gate.

5. The power supply device of claim 3 wherein the second switch element is a second diode, the first terminal of the second switch is an N-pole, and the second terminal of the second switch element is a P-pole.

6. The power supply device of claim 5 wherein the second diode is implemented by a metal-oxide semiconductor transistor.

7. The power supply device of claim 3 wherein the control element comprises:
a voltage-division circuit coupled to the second terminal of the second switch element for generating a divided voltage;
a reference voltage generator for generating a reference voltage;
a comparison circuit coupled to the voltage-division circuit and to the reference voltage generator, for comparing the divided voltage with the reference voltage; and
an oscillator coupled to the comparison circuit and to the third terminal of the first switch element, for adjusting a duty cycle of a signal outputted to the third terminal of the first switch element according to a comparison result of the comparison circuit.

8. The power supply device of claim 7 wherein the oscillator is a pulse width modulating oscillator.

9. The power supply device of claim 3 wherein the DC power transformation module further comprises:
a capacitor coupled to the output end of the DC power transformation module and to the system ground.

10. The power supply device of claim 1 wherein the DC power transformation module is a voltage-reduction DC-to-DC voltage transformation circuit, the DC power transformation module comprising:
a first switch element having a first terminal coupled to the DC power output module, a second terminal, and a third terminal, for transmitting a signal of the first terminal of the first switch element to the second terminal of the first switch element according to a signal received at the third terminal of the first switch element;
a second switch element having a first terminal coupled to a ground, and a second terminal coupled to the second terminal of the first switch element, for transmitting a signal of the first terminal of the second switch to the second terminal of the second switch when a voltage of the signal of the first terminal of the second switch element is higher than a first value;
an inductor having a first terminal coupled to the second terminal of the first switch element and to the first terminal of the second switch element, and a second terminal coupled to the input end of the first diode; and
a control element coupled to the second terminal of the inductor and the third terminal of the first switch element, for controlling a duty cycle of the first switch element according to a power source outputted at the second terminal of the inductor.

11. The power supply device of claim 10 wherein the first switch element is a metal-oxide semiconductor transistor, the first terminal of the first switch element is a drain, the second terminal of the first switch element is a source, and the third terminal of the first switch element is a gate.

12. The power supply device of claim 10 wherein the second switch element is a second diode, the first terminal of the second switch element is an N-pole, and the second terminal of the second switch element is a P-pole.

13. The power supply device of claim 12 wherein the second diode is implemented by a metal-oxide semiconductor transistor.

14. The power supply device of claim 10 wherein the control element comprises:
a voltage-division circuit coupled to the second terminal of the inductor, for generating a divided voltage;
a reference voltage generator for generating a reference voltage;
a comparison circuit coupled to the voltage-division circuit and to the reference voltage generator, for comparing the divided voltage with the reference voltage; and
an oscillator coupled to the comparison circuit and to the third terminal of the first switch element, for adjusting a duty cycle of a signal outputted to the third terminal of the first switch element according to a comparison result of the comparison circuit.

15. The power supply device of claim 14 wherein the oscillator is a pulse width modulation oscillator.

16. The power supply device of claim 3 wherein the DC power transformation module further comprises:
a capacitor coupled to the output end of the DC power transformation module and the system ground.

17. The power supply device of claim 1 wherein the first loading unit comprises:
a real time clock generating module.

18. The power supply device of claim 17 wherein the first loading unit further comprises:
a storing module.

19. The power supply device of claim 1 wherein the charge storing module comprises:
a resistor having a terminal coupled to the output end of the first diode; and
a chargeable battery coupled to another terminal of the resistor.

20. The power supply device of claim 1 wherein the output end of the DC power transformation module is further coupled to a second loading unit.

21. The power supply device of claim 20 further comprising a switch unit coupled to the output end of the DC power transformation module and to the second loading unit.

22. The power supply device of claim 21 wherein the switch unit generates a current path between the output end of the DC power transformation module and the second loading unit when the electronic device is activated.

23. The power supply device of claim 20 wherein the second loading unit is a chip.
